(19) United States
(12) Patent Application Publication
(10) Pub. No.: US 2024/0031865 A1
(43) Pub. Date: Jan. 25, 2024

(54) MACHINE LEARNING-BASED PCELL AND SCELL THROUGHPUT DISTRIBUTION

(71) Applicant: T-Mobile Innovations LLC, Overland Park, KS (US)

(72) Inventors: Akin Ozozlu, McLean, VA (US); Nagi A. Mansour, Arlington, VA (US)

(21) Appl. No.: 17/871,275

(22) Filed: Jul. 22, 2022

(51) Int. Cl. H04W 28/08; H04W 28/02

(52) U.S. Cl. CPC H04W 28/0804; H04W 28/0958; H04W 28/0289

(57) ABSTRACT

Data load allocation in a wireless network is provided herein. The system includes a user equipment (UE) and a cell. The method begins with determining radio condition metrics for a plurality of cells used for communication between the plurality of cells and the UE. A congestion metric is also determined for each cell of the plurality of cells. The radio condition metrics and the congestion metric for each cell of the plurality of cells is input to a neural network and a deep learning module. Based on the radio condition metrics and the congestion metric for each of the plurality of cells and the output from at least one of the neural network and the deep learning module, a first fraction of a data load is allocated to a first cell of the plurality of cells. A scheduler then schedules the first fraction of the data load for transmission.

### BACKGROUND

Mobile devices depend on radio frequencies to connect to a mobile network. In 5G and 6G networks carrier aggregation systems assign user equipment (UE) to specific frequency allocations and cells. Existing carrier aggregation systems statically assign primary cells (Pcells) and secondary cells (Scells), which causes throughput disruption when RF conditions deteriorate. Static assignments can cause data to be sent inefficiently or wastefully. In some instances precious low-band spectrum is used to send data which could be sent over mid-band spectrum or high-band spectrum. This can persist as long as the static assignment and limits throughput through the network.

### SUMMARY

A high-level overview of various aspects of the present technology is provided in this section to introduce a selection of concepts that are further described below in the detailed description section of this disclosure. This summary is not intended to identify key or essential features of the claimed subject matter, nor is it intended to be used as an aid in isolation to determine the scope of the claimed subject matter.

According to aspects herein, methods and systems for data load allocation in a wireless network are provided. The method begins with determining radio condition metrics for a plurality of cells used in communication between each of the plurality of cells and a user equipment (UE). The network can be a 5G or 6G network system and can be a dual connectivity network. The method continues with determining a congestion metric for each of the plurality of cells. The radio condition metrics and the congestion metric for each of the plurality of cells are input to a neural network and to a deep learning module. The neural network and deep learning module use the radio condition metrics and the congestion metric to analyze the traffic flow and conditions at each of the plurality of cells. The cell may be a primary cell (Pcell) or a secondary cell (Scell) in a dual connectivity network. At least one of the neural network the deep learning module determines a first fraction of a data load to a first cell of the plurality of cells. A scheduler then schedules the first fraction of the data load to the cell.

In a further embodiment, a system for data load allocation is provided. The system includes a base station having at least one primary cell and at least one secondary cell. Each of the primary and secondary cells has one or more antennas for receiving radio condition metrics and transmitting data load allocations, and a processor. The processor is configured to determine radio condition metrics for the at least one primary cell and the at least one secondary cell. The processor also determines a first congestion metric for at least one primary cell and a second congestion metric for at least one secondary cell. The radio condition metrics for both the primary and secondary cells, along with the first and second congestion metrics are input to at least one of a neural network and a deep learning module. Based on the radio condition metrics for the at least one primary cell and the at least one secondary cell, as well as the first and second congestion metrics, the output from at least one of the neural network and the deep learning module, a first fraction of the data load is allocated to the at least one primary cell.

An additional embodiment provides a non-transitory computer storage media storing computer-useable instructions that, when executed by one or more processors cause the processors to determine radio condition metrics for a plurality of cells used for communication between the plurality of cells and a UE. The processors also determine a congestion metric for the plurality of cells. The processors also receive, from a scheduler, a first fraction of a data load allocated to a first cell of the plurality of cells. The data load allocated is based on the radio condition metrics and the congestion metric.

### BRIEF DESCRIPTION OF THE SEVERAL VIEWS OF THE DRAWINGS

Implementations of the present disclosure are described in detail below with reference to the attached drawing figures, wherein:

FIG. 1 depicts a diagram of an exemplary network environment in which implementations of the present disclosure may be employed, in accordance with aspects herein;

FIG. 2 depicts a cellular network suitable for use in implementations of the present disclosure, in accordance with aspects herein;

FIG. 3 depicts a dual connectivity network environment suitable for use in implementations of the present disclosure, in accordance with aspects herein;

FIG. 4 depicts artificial intelligence (AI) based primary cell (Pcell) and secondary cell (Scell) data load allocation, in which implementations of the present disclosure may be employed, in accordance with aspects herein;

FIG. 5 is a flow diagram of an exemplary method for data load allocation, in which aspects of the present disclosure may be employed, in accordance with aspects herein; and

FIG. 6 depicts an exemplary computing device suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:

| | |
|---|---|
| 3G | Third-Generation Wireless Technology |
| 4G | Fourth-Generation Cellular Communication System |
| 5G | Fifth-Generation Cellular Communication System |
| 6G | Sixth-Generation Cellular Communication System |
| AI | Artificial Intelligence |
| CD-ROM | Compact Disk Read Only Memory |
| CDMA | Code Division Multiple Access |
| eNodeB | Evolved Node B |
| GIS | Geographic/Geographical/Geospatial Information System |
| gNodeB | Next Generation Node B |
| GPRS | General Packet Radio Service |
| GSM | Global System for Mobile communications |
| iDEN | Integrated Digital Enhanced Network |
| DVD | Digital Versatile Discs |
| EEPROM | Electrically Erasable Programmable Read Only Memory |
| LED | Light Emitting Diode |
| LTE | Long Term Evolution |
| MIMO | Multiple Input Multiple Output |
| MD | Mobile Device |
| ML | Machine Learning |
| PC | Personal Computer |
| PCS | Personal Communications Service |
| PDA | Personal Digital Assistant |
| PDSCH | Physical Downlink Shared Channel |
| PHICH | Physical Hybrid ARQ Indicator Channel |
| PUCCH | Physical Uplink Control Channel |
| PUSCH | Physical Uplink Shared Channel |
| RAM | Random Access Memory |
| RET | Remote Electrical Tilt |
| RF | Radio-Frequency |
| RFI | Radio-Frequency Interference |
| R/N | Relay Node |
| RNR | Reverse Noise Rise |
| ROM | Read Only Memory |
| RSRP | Reference Transmission Receive Power |
| RSRQ | Reference Transmission Receive Quality |
| RSSI | Received Transmission Strength Indicator |
| SINR | Transmission-to-Interference-Plus-Noise Ratio |
| SNR | Transmission-to-noise ratio |
| SON | Self-Organizing Networks |
| TDMA | Time Division Multiple Access |
| TXRU | Transceiver (or Transceiver Unit) |
| UE | User Equipment |
| UMTS | Universal Mobile Telecommunications Systems |
| WCD | Wireless Communication Device (interchangeable with UE) |

Further, various technical terms are used throughout this description. An illustrative resource that fleshes out various aspects of these terms can be found in Newton's Telecom Dictionary, 25th Edition (2009).

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, a traditional telecommunications network employs a plurality of base stations (i.e., access point, node, cell sites, cell towers) to provide network coverage. The base stations are employed to broadcast and transmit transmissions to user devices of the telecommunications network. An access point may be considered to be a portion of a base station that may comprise an antenna, a radio, and/or a controller. In aspects, an access point is defined by its ability to communicate with a user equipment (UE), such as a wireless communication device (WCD), according to a single protocol (e.g., 3G, 4G, LTE, 5G, and the like); however, in other aspects, a single access point may communicate with a UE according to multiple protocols. As used herein, a base station may comprise one access point or more than one access point. Factors that can affect the telecommunications transmission include, e.g., location and size of the base stations, and frequency of the transmission, among other factors. The base stations are employed to broadcast and transmit transmissions to user devices of the telecommunications network. Traditionally, the base station establishes uplink (or downlink) transmission with a mobile handset over a single frequency that is exclusive to that particular uplink connection (e.g., an LTE connection with an EnodeB). In this regard, typically only one active uplink connection can occur per frequency. The base station may include one or more sectors served by individual transmitting/receiving components associated with the base station (e.g., antenna arrays controlled by an EnodeB). These transmitting/receiving components together form a multi-sector broadcast arc for communication with mobile handsets linked to the base station.

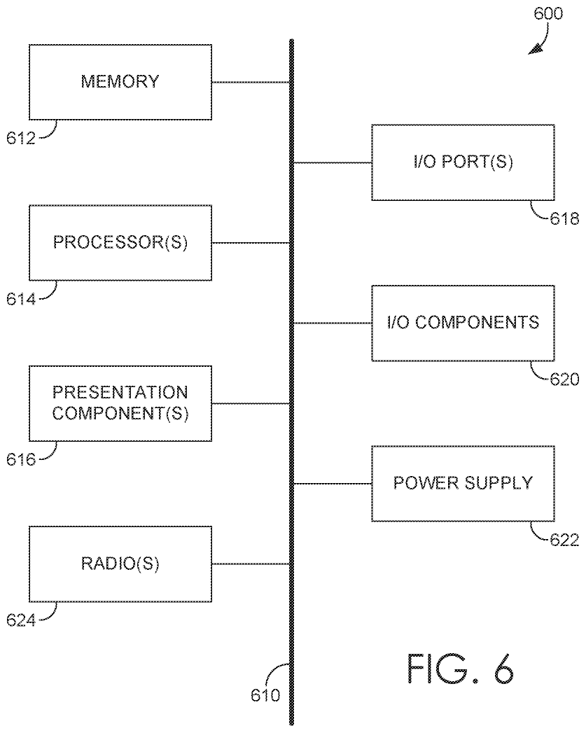

As used herein, “base station” is one or more transmitters or receivers or a combination of transmitters and receivers, including the accessory equipment, necessary at one location for providing a service involving the transmission, emission, and/or reception of radio waves for one or more specific telecommunication purposes to a mobile station (e.g., a UE), wherein the base station is not intended to be used while in motion in the provision of the service. The term/abbreviation UE (also referenced herein as a user device or wireless communications device (WCD)) can include any device employed by an end-user to communicate with a telecommunications network, such as a wireless telecommunications network. A UE can include a mobile device, a mobile broadband adapter, or any other communications device employed to communicate with the wireless telecommunications network. A UE, as one of ordinary skill in the art may appreciate, generally includes one or more antennas coupled to a radio for exchanging (e.g., transmitting and receiving) transmissions with a nearby base station. A UE may be, in an embodiment, similar to device 600 described herein with respect to FIG. 6.

As used herein, UE (also referenced herein as a user device or a wireless communication device) can include any device employed by an end-user to communicate with a wireless telecommunications network. A UE can include a mobile device, a mobile broadband adapter, a fixed location or temporarily fixed location device, or any other communications device employed to communicate with the wireless telecommunications network. For an illustrative example, a UE can include cell phones, smartphones, tablets, laptops, small cell network devices (such as micro cell, pico cell, femto cell, or similar devices), and so forth. Further, a UE can include a sensor or set of sensors coupled with any other communications device employed to communicate with the wireless telecommunications network; such as, but not limited to, a camera, a weather sensor (such as a rain gage, pressure sensor, thermometer, hygrometer, and so on), a motion detector, or any other sensor or combination of sensors. A UE, as one of ordinary skill in the art may appreciate, generally includes one or more antennas coupled to a radio for exchanging (e.g., transmitting and receiving) transmissions with a nearby base station or access point.

In aspects, a UE provides UE data including location and channel quality information to the wireless communication network via the access point. Location information may be based on a current or last known position utilizing GPS or other satellite location services, terrestrial triangulation, an access point's physical location, or any other means of obtaining coarse or fine location information. Channel quality information may indicate a realized uplink and/or downlink transmission data rate, observed signal-to-interference-plus-noise ratio (SINR) and/or signal strength at the user device, or throughput of the connection. Channel quality information may be provided via, for example, an uplink pilot time slot, downlink pilot time slot, sounding reference signal, channel quality indicator (CQI), rank indicator, precoding matrix indicator, or some combination thereof. Channel quality information may be determined to be satisfactory or unsatisfactory, for example, based on exceeding or being less than a threshold. Location and channel quality information may take into account the user device capability, such as the number of antennas and the type of receiver used for detection. Processing of location and channel quality information may be done locally, at the access point or at the individual antenna array of the access point. In other aspects, the processing of said information may be done remotely.

A service state of the UEs may include, for example, an in-service state when a UE is in-network (i.e., using services of a primary provider to which the UE is subscribed to, otherwise referred to as a home network carrier), or when the UE is roaming (i.e., using services of a secondary provider providing coverage to the particular geographic location of the UE that has agreements in place with the primary provider of the UE). The service state of the UE may also include, for example, an emergency only state when the UE is out-of-network and there are no agreements in place between the primary provider of the UE and the secondary provider providing coverage to the current geographic location of the UE. Finally, the service state of the UE may also include, for example, an out of service state when there are no service providers at the particular geographic location of the UE.

The UE data may be collected at predetermined time intervals measured in milliseconds, seconds, minutes, hours, or days. Alternatively, the UE data may be collected continuously. The UE data may be stored at a storage device of the UE, and may be retrievable by the UE's primary provider as needed and/or the UE data may be stored in a cloud based storage database and may be retrievable by the UE's primary provider as needed. When the UE data is stored in the cloud based storage database, the data may be stored in association with a data identifier mapping the UE data back to the UE, or alternatively, the UE data may be collected without an identifier for anonymity.

In accordance with a first aspect of the present disclosure a method for data load allocation in a wireless network is provided. The method begins with determining radio condition metrics for a plurality of cells used for communication between each of the plurality of cells a cell and a user equipment (UE). Next, a congestion metric is determined for each cell. The radio condition metrics and the congestion metric for each of the plurality of cells is then input to a neural network and a deep learning module. Based on the radio condition metrics and the congestion metric for each of the plurality of cells as well as the output from at least one of the neural network and the deep learning module, allocating a first fraction of a data load to a first cell of the plurality of cells. The first fraction of the data load is then scheduled for transmission.

A second aspect of the present disclosure provides a system for data load allocation. The system includes a base station having at least one primary cell and at least one secondary cell. The primary cell and the secondary cell can from a dual connectivity system. Both the at least one primary cell and the at least one secondary cell have one or more antennas for receiving radio condition metrics and for transmitting data load allocations. The base station also includes a processor, which is configured to determine radio condition metrics for the at least one primary cell and the at least one secondary cell. A first congestion metric is determined for the at least one primary cell and a second congestion metric is determined for the at least one secondary cell. Both the radio condition metrics and the congestion metrics are input to at least one of a neural network and a deep learning module. Based on the radio condition metric and the first and second congestion metrics and the output from at least one of the neural network and the deep learning module, a first fraction of the data is allocated to the at least one primary cell.

Another aspect of the present disclosure is directed to a non-transitory computer storage media storing computer-useable instructions that, when used by one or more processors, cause the processors to determine radio condition metrics for a plurality of cells used for communication between the plurality of cells and a user equipment (UE). The processors also determine a congestion metric for each cell of the plurality of cells. A scheduler determines a first fraction of a data load allocated to a first cell of the plurality of cells and the UE, with the first fraction of the data load allocated to the first cell of the plurality of cells and the UE determined based on the radio condition metrics and the congestion metric.

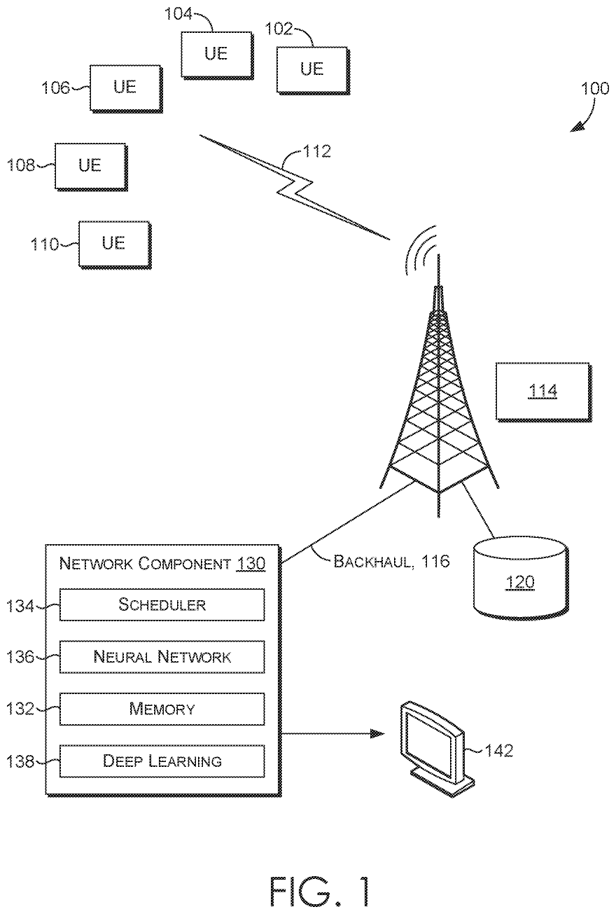

FIG. 1 illustrates an example of a network environment 100 suitable for use in implementing embodiments of the present disclosure. The network environment 100 is but one example of a suitable network environment and is not intended to suggest any limitation as to the scope of use or functionality of the disclosure. Neither should the network environment 100 be interpreted as having any dependency or requirement

Network environment 100 includes user devices (UE) 102, 104, 106, 108, and 110, access point 114 (which may be a cell site, base station, or the like), and one or more communication channels 112. The communication channels 112 can communicate over frequency bands assigned to the carrier. In network environment 100, user devices may take on a variety of forms, such as a personal computer (PC), a user device, a smart phone, a smart watch, a laptop computer, a mobile phone, a mobile device, a tablet computer, a wearable computer, a personal digital assistant (PDA), a server, a CD player, an MP3 player, a global positioning system (GPS) device, a video player, a handheld communications device, a workstation, a router, a hotspot, and any combination of these delineated devices, or any other device (such as the computing device 600) that communicates via wireless communications with the access point 114 in order to interact with a public or private network.

In some aspects, each of the UEs 102, 104, 106, 108, and 110 may correspond to computing device 600 in FIG. 6. Thus, a UE can include, for example, a display(s), a power source(s) (e.g., a battery), a data store(s), a speaker(s), memory, a buffer(s), a radio(s) and the like. In some implementations, for example, a UEs 102, 104, 106, 108, and 110 comprise a wireless or mobile device with which a wireless telecommunication network(s) can be utilized for communication (e.g., voice and/or data communication). In this regard, the user device can be any mobile computing device that communicates by way of a wireless network, for example, a 3G, 4G, 5G, LTE, CDMA, or any other type of network.

In some cases, UEs 102, 104, 106, 108, and 110 in network environment 100 can optionally utilize one or more communication channels 112 to communicate with other computing devices (e.g., a mobile device(s), a server(s), a personal computer(s), etc.) through access point 114. Access point 114 may be a gNodeB in a 5G or 6G network. In addition, access point 114 may also be known as a base station. For example, a carrier can have two frequency bands FR1 and FR2. FR1 can cover 4.1 GHz to 7.125 GHz and FR2 can cover 24.25 GHz to 52.6 GHz. A carrier, or mobile network operator, may consider carrier aggregation (CA), which allows use of multiple sub-6 GHz spectrum channels simultaneously. CA groups several frequency bands to provide higher peak rates and increased cell coverage. In addition, CA extends coverage and increases network capacity. To further increase network performance frequency division duplex (FDD) and/or time division duplex (TDD) carrier aggregation can be implemented.

FDD and TDD are two different spectrum usage techniques. While FDD uses separate frequencies for uplink and downlink communication, TDD uses a single frequency for both uplink and downlink, with devices transmitting a different times. TDD can be more suitable when paired spectrum resources are not available. In general, FDD can provide better coverage, while TDD can provide better capacity.

The network environment 100 may be comprised of a telecommunications network(s), or a portion thereof. A telecommunications network might include an array of devices or components (e.g., one or more base stations), some of which are not shown. Those devices or components may form network environments similar to what is shown in FIG. 1, and may also perform methods in accordance with the present disclosure. Components such as terminals, links, and nodes (as well as other components) can provide connectivity in various implementations. Network environment 100 can include multiple networks, as well as being a network of networks, but is shown in more simple form so as to not obscure other aspects of the present disclosure.

The one or more communication channels 112 can be part of a telecommunication network that connects subscribers to their immediate telecommunications service provider (i.e., home network carrier). In some instances, the one or more communication channels 112 can be associated with a telecommunications provider that provides services (e.g., 3G network, 4G network, LTE network, 5G network, and the like) to user devices, such as UEs 102, 104, 106, 108, and 110. For example, the one or more communication channels may provide voice, SMS, and/or data services to UEs 102, 104, 106, 108, and 110, or corresponding users that are registered or subscribed to utilize the services provided by the telecommunications service provider. The one or more communication channels 112 can comprise, for example, a 1× circuit voice, a 3G network (e.g., CDMA, CDMA2000, WCDMA, GSM, UMTS), a 4G network (WiMAX, LTE, HSDPA), or a 5G network or a 6G network.

In some implementations, access point 114 is configured to communicate with a UE, such as UEs 102, 104, 106, 108, and 110, that are located within the geographic area, or cell, covered by radio antennas of access point 114. Access point 114 may include one or more base stations, base transmitter stations, radios, antennas, antenna arrays, power amplifiers, transmitters/receivers, digital signal processors, control electronics, GPS equipment, and the like. In particular, access point 114 may selectively communicate with the user devices using dynamic beamforming.

As shown, access point 114 is in communication with a network component 130 and at least a network database 120 via a backhaul channel 116. As the UEs 102, 104, 106, 108, and 110 collect individual status data, the status data can be automatically communicated by each of the UEs 102, 104, 106, 108, and 110 to the access point 114. Access point 114 may store the data communicated by the UEs 102, 104, 106, 108, and 110 at a network database 120. Alternatively, the access point 114 may automatically retrieve the status data from the UEs 102, 104, 106, 108, and 110, and similarly store the data in the network database 120. The data may be communicated or retrieved and stored periodically within a predetermined time interval which may be in seconds, minutes, hours, days, months, years, and the like. With the incoming of new data, the network database 120 may be refreshed with the new data every time, or within a predetermined time threshold so as to keep the status data stored in the network database 120 current. For example, the data may be received at or retrieved by the access point 114 every 10 minutes and the data stored at the network database 120 may be kept current for days, which means that status data that is older than 30 days would be replaced by newer status data at 10 minute intervals. As described above, the status data collected by the UEs 102, 104, 106, 108, and 110 can include, for example, service state status, the respective UE's current geographic location, a current time, a strength of the wireless signal, available networks, and the like.

The network component 130 comprises a memory 132, a scheduler 134, a neural network 136, and a deep learning module 138. All determinations, calculations, and data further generated by the scheduler 134, the neural network 136 and the deep learning module 138 may be stored at the memory 132 and also at the data store 140. Although the network component 130 is shown as a single component comprising the memory 132, the scheduler 134, the neural network 136, the deep learning module 138, and the data store 140, it is also contemplated that each of the memory 132, the scheduler 134, the neural network 136, and the deep learning module 138 may reside at different locations, be its own separate entity, and the like, within the home network carrier system.

The network component 130 is configured to retrieve signal quality metrics and carrier loading metrics from the base station or access point 114 or one of the UEs, 102, 104, 106, 108, and 110. Signal quality metrics can include any one or more of multiple metrics, such as signal-to-interference and noise (SINR), reference signal received power (RSRP), and reference signal received quality (RSRQ). The network component 130 can also track uplink and downlink user traffic. The scheduler 134 can be an artificial intelligence (AI) based scheduler that can observe application usage using measurement metrics such as SINR, RSRP, and RSRQ and can extract a traffic or packet generation model using deep packet inspection. The scheduler 134 can be located in a central office or other centralized location for a virtualized radio access network. For a distributed radio access network, the scheduler 134 can be located at the access point 114. The access point 114 may be a gNodeB that interfaces with the scheduler 134. The scheduler 134 determines what percentage of data is sent over Pcells and what percentage of data is sent over Scells. This determination is based on the radio conditions of the Pcell and the Scell.

A traffic or packet generation model is a model of the packet flows or data sources in a packet switched network. Deep packet inspection is a type of network packet filtering and may also be known as complete packet inspection. Deep packet inspection evaluates the data part and the header of a packet transmitted through an inspection point. The inspection points weeding out non-compliant packets, spam, viruses, and any other defined criteria to block the packet at the inspection point. Deep packet inspection may also be used to decide if a particular packet should be redirected to another destination. Deep packet inspection can be used to locate, detect, categorize, block, or reroute packets having a specific code or data payloads that are not detected, located, categorized, block or redirected by conventional packet filtering. Ordinary packet filtering, or plain packet filtering, examines only packet headers. In contrast, deep packet filtering evaluates the contents of a packet in accordance with rules applicable in the network, determines what to do with the packets in real time. Deep packet filtering can also determine the source of the packets, such as an application or service.

The neural network 136 can be a deep neural network that continuously observes traffic and key performance indicators of the network, such as user throughput and traffic volume. The data can include radio conditions and traffic using each access point 114. The data can be stored in the memory 132 for access by the scheduler 134, neural network 136, and deep learning module 138. The neural network 136 can be a recurrent neural network.

The deep learning module 138 uses a machine learning model that is retrained at least one every twenty-four hours and on-demand based on high traffic volume. A machine learning model focuses on enabling computers to perform tasks without explicit programming. Deep learning is a subset of machine learning that is based on artificial neural networks. Training using deep learning requires high data volume, which is available in wireless communication networks and other computer-based networks in the 5G ecosystem. The deep learning module 138 can use a machine learning model or a deep neural network and may use a recurrent neural network that keeps past data points and selections “in mind” during the learning process and can consider those past data points and selections when reviewing current data, thus introducing context.

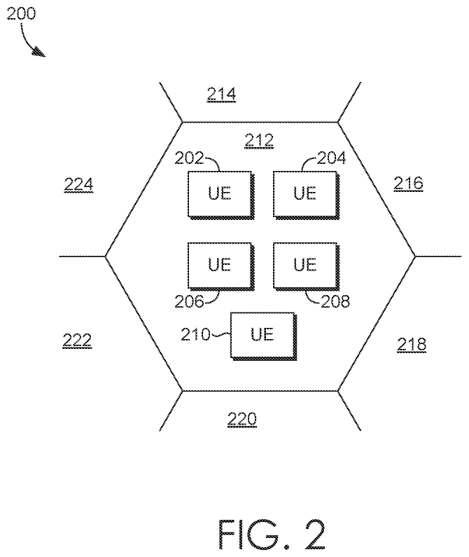

FIG. 2 depicts a cellular network suitable for use in implementations of the present disclosure, in accordance with aspects herein. For example, as shown in FIG. 2, each geographic area in the plurality of geographic areas may have a hexagonal shape such as hexagon representing a geographic area 200 having cell sites 212, 214, 216, 218, 220, 222, 224, each including base station or access point 114, backhaul channel 116, antenna for sending and receiving signals over communication channels 112, network database 120 and network component 130. The size of the geographic area 200 may be predetermined based on a level of granularity, detail, and/or accuracy desired for the determinations/calculations done by the systems, computerized methods, and computer-storage media. A plurality of UEs may be located within each geographic area collecting UE data within the geographic area at a given time. For example, as shown in FIG. 2, UEs 202, 204, 206, 208, and 210, may be located within geographic area 200 collecting UE data that is useable by network component 130, in accordance with aspects herein. UEs 202, 204, 206, 208, and 210 can move within the cell currently occupying, such as cell 212 and can move to other cells such as adjoining cells 214, 216, 218, 220, 222 and 224.

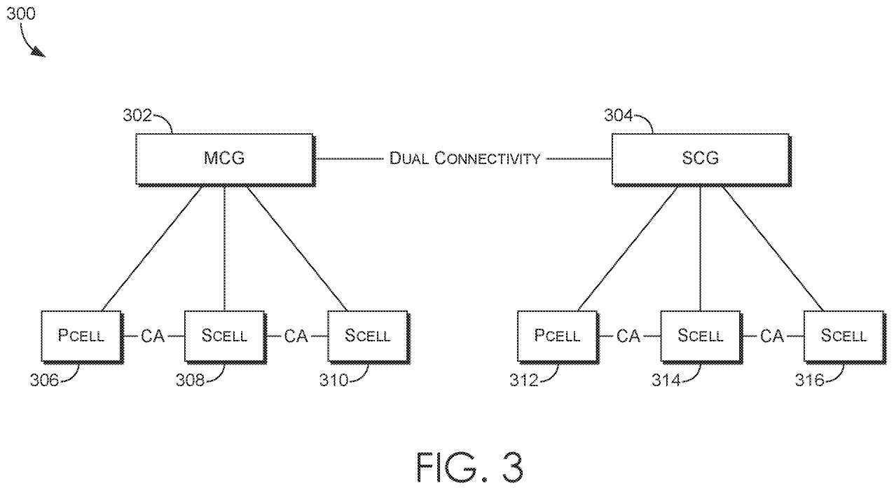

FIG. 3 depicts a dual connectivity network environment suitable for use in implementations of the present disclosure, in accordance with aspects herein. The cell sites discussed above in FIG. 2 may be dual connectivity cells in a 5G or 6G network. A dual connectivity cell 300 can include a master cell group (MCG) 302 and at least one secondary cell group (SCG) 304. The MCG 302 is connected to SCG 304 through dual connectivity. The MCG 302 can be located in a group in which a cell with which a UE, such as UEs 202, 204, 206, 208, and 210 in FIG. 2, first initiates random access.

There can be many cells under the MCG 302. A cell that is used to initiate initial access to the cell can be known as a Primary Cell (Pcell). The Pcell can be combined with a Secondary Cell (Scell) using carrier aggregation. The MCG 302 may be connected to a Pcell 306 and also, through carrier aggregation to Scell 308. Scell 308 is also in communication with MCG 308 and through carrier aggregation, Scell 310. Scell 310 is also in communication with MCG 302.

Similarly, the Secondary Cell Group (SCG) 304 is in communication with Pcell 312. Pcell 312 is in communication with Scell 314 through carrier aggregation. Scell 314 is also in communication with SCG 304. Scell 316 is in communication with Scell 314 using carrier aggregation and is also in communication with SCG 304.

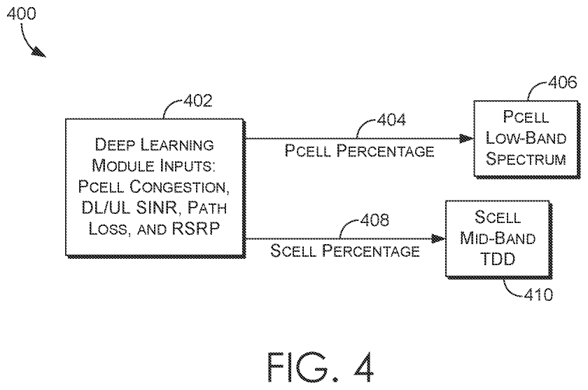

FIG. 4 depicts artificial intelligence (AI) based primary cell (Pcell) and secondary cell (Scell) data load allocation, in which implementations of the present disclosure may be employed, in accordance with aspects herein. The data load allocation process 400 begins with the deep learning module 138 inputs the observations of the scheduler 134. These observations of the traffic by the scheduler 134 can include: application usage, congestion, both Pcell and Scell, downlink SINR, uplink SINR, uplink path loss and downlink path loss. The observed information is passed to the deep learning module 138 at process step 402. At process step 402 the deep learning module determines, based on the input observations, what percentage of data should be sent over a Pcell. The data is then transmitted by the Pcell at process step 406. The data to be transmitted by the Pcell is determined by the deep learning module 138 based on considerations including the input observations as well as time transmission intervals, or unit of time, seconds. The remaining traffic is then transmitted by the Scell at process step 410.

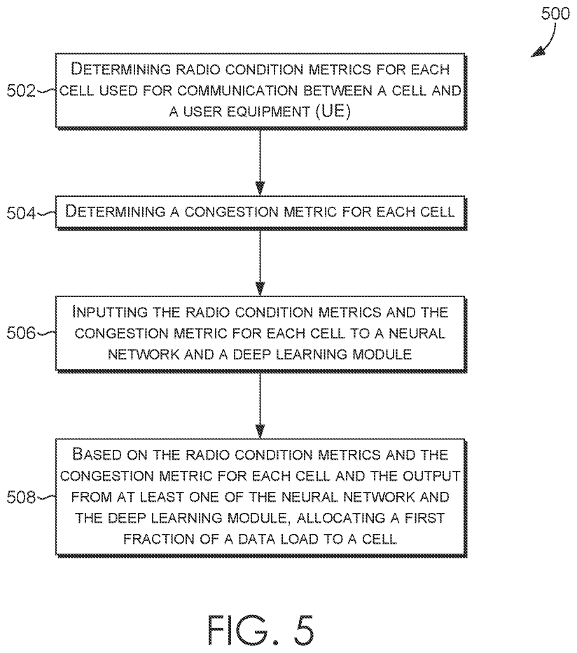

FIG. 5 is a flow diagram of an exemplary method for data load allocation, in which aspects of the present disclosure may be employed, in accordance with aspects herein. The method 500 begins with determining radio condition metrics for each cell used for communication between a cell and a user equipment (UE), in step 502. The cells can be Pcells or Scells in a dual connectivity system as described above in FIG. 3. The radio condition metrics can include signal-to-interference and noise (SINR), reference signal received power (RSRP), reference signal received quality (RSRQ), or other measurement of the condition of the radio link between a serving cell and a UE. Next, in step 504 a congestion metric is determined for each cell. The congestion metric can be determined for both Pcells and Scells and the Pcells and Scells can be commonly located at an access point or base station as described above in FIG. 1. Congestion metrics can include a number of UEs currently served by a Pcell or Scell, a number of UEs currently served by a base station or access point, a number of UEs accessing the cell or base station at a particular point in time, a traffic assessment of cell traffic anticipated to access a particular cell or access point based on previous traffic history, and similar measures of congestion.

The method for data allocation continues in step 506, which provides for inputting the radio condition metrics and the congestion metric for each cell to a neural network and a deep learning module. The neural network model can store the radio condition metrics and the congestion metrics for each cell and can analyze the use pattern of the cell. During this process, the neural network learns the traffic patterns and radio conditions for varying loads and how those loads can vary over the course of a day. The deep learning network can also perform learning operations to further refine and enhance automated operations through the use of large data sets, such as the daily traffic flowing through an access point. Then in step 508, based on the radio condition metrics and the congestion metric for each cell and the output from at least one of the neural network and the deep learning module, allocating a first fraction of a data load to a cell. The fraction can be expressed as a percentage of the data flowing through the cell and can also be a percentage of the Pcell low band spectrum. A second fraction of the data flowing through the cell can be a percentage or all of the data remaining after the Pcell fraction, or first fraction, has been determined. The second fraction is transmitted using a Scell and uses mid-band time division duplex (TDD) channels.

FIG. 6 depicts an exemplary computing device suitable for use in implementations of the present disclosure, in accordance with aspects herein. With continued reference to FIG. 6, computing device 600 includes bus 602 that directly or indirectly couples the following devices: memory 604, one or more processors 606, one or more presentation components 608, input/output (I/O) ports 612, I/O components 610, radio 616, transmitter 618, and power supply 614. Bus 602 represents what may be one or more busses (such as an address bus, data bus, or combination thereof). Although the devices of FIG. 6 are shown with lines for the sake of clarity, in reality, delineating various components is not so clear, and metaphorically, the lines would more accurately be grey and fuzzy. For example, one may consider a presentation component such as a display device to be one of I/O components 610. Also, processors, such as one or more processors 606, have memory. The present disclosure hereof recognizes that such is the nature of the art, and reiterates that FIG. 6 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 6 and refer to “computer” or “computing device.”

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 604 includes computer-storage media in the form of volatile and/or nonvolatile memory. Memory 604 may be removable, nonremovable, or a combination thereof. Exemplary memory includes solid-state memory, hard drives, optical-disc drives, etc. Computing device 600 includes one or more processors 606 that read data from various entities such as bus 602, memory 604 or I/O components 610. One or more presentation components 608 present data indications to a person or other device. Exemplary one or more presentation components 408 include a display device, speaker, printing component, vibrating component, etc. I/O ports 612 allow computing device 600 to be logically coupled to other devices including I/O components 610, some of which may be built into computing device 600. Illustrative I/O components 610 include a microphone, joystick, game pad, satellite dish, scanner, printer, wireless device, etc.

The radio 616 represents one or more radios that facilitate communication with a wireless telecommunications network. While a single radio 616 is shown in FIG. 6, it is contemplated that there may be more than one radio 616 coupled to the bus 602. In aspects, the radio 616 utilizes a transmitter 618 to communicate with the wireless telecommunications network. It is expressly conceived that a computing device with more than one radio 616 could facilitate communication with the wireless telecommunications network via both the first transmitter 618 and an additional transmitters (e.g. a second transmitter). Illustrative wireless telecommunications technologies include CDMA, GPRS, TDMA, GSM, and the like. The radio 616 may additionally or alternatively facilitate other types of wireless communications including Wi-Fi, WiMAX, LTE, 3G, 4G, LTE, 5G, NR, VoLTE, or other VoIP communications. As can be appreciated, in various embodiments, radio 616 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

Many different arrangements of the various components depicted, as well as components not shown, are possible without departing from the scope of the claims below. Embodiments of our technology have been described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

The invention claimed is:

1. A method for data load allocation in a wireless network, comprising:
determining radio condition metrics for a plurality of cells used for communication between each of the plurality of cells and a user equipment (UE);
determining a congestion metric for each of the plurality of cells;
inputting the radio condition metrics and the congestion metric for each of the plurality of cells to a neural network and a deep learning module;
based on the radio condition metrics and the congestion metric for each of the plurality of cells and an output from at least one of the neural network and the deep learning module, allocating a first fraction of a data load to a first cell of the plurality of cells and
scheduling the first fraction of the data load for transmission.

2. The method of claim 1, wherein the first fraction of the data load is sent using a primary cell (Pcell).

3. The method of claim 2, wherein the first fraction of the data load allocated is sent using low band frequencies.

4. The method of claim 1, further comprising allocating a second fraction of the data load to a second cell of the plurality of cells.

5. The method of claim 4, wherein the second fraction of the data load is an amount of data remaining to be allocated after the first fraction of the data load has been determined.

6. The method of claim 5, wherein the second fraction of the data load is sent using a secondary cell (Scell).

7. The method of claim 6, wherein the second fraction of the data load sent to the Scell uses mid-band time division duplex (TDD) frequencies of the spectrum.

8. The method of claim 1, wherein the radio condition metrics comprise at least one of: signal-to-interference and noise (SINR), reference signal received power (RSRP), and reference signal received quality (RSRP).

9. The method of claim 1, wherein the congestion metrics comprise at least one of: a number of UEs connected to a primary cell (Pcell) and a number of UEs connected to a secondary cell (Scell), a number of UEs using an access point hosting a Pcell and a Scell, and a traffic metric based on a time of day.

10. A system for data load allocation, comprising:
a base station having at least one primary cell and at least one secondary cell, the at least one secondary cell, the at least one primary cell and the at least one secondary cell having one or more antennas for receiving radio condition metrics and transmitting data load allocations, and a processor, the processor configured to:
determine radio condition metrics for the at least one primary cell and the at least one secondary cell;
determine a first congestion metric for the at least one primary cell and a second congestion metric for the at least one secondary cell;
input the radio condition metric for the at least one primary cell, the radio condition metric for the at least one secondary cell, the first congestion metric and the second congestion metric to at least one of a neural network and a deep learning module; and
based on the radio condition metric for the at least one primary cell, the radio condition metric for the at least one secondary cell, the first congestion metric and the second congestion metric, and an output from at least one of the neural network and the deep learning module, allocate a first faction of a data load to the at least one primary cell.

11. The system of claim 10, wherein the first fraction of the data load is sent using low band frequencies.

12. The system of claim 10, further comprising allocating a second fraction of the data load, wherein the second fraction of the data load is an amount of data remaining to be allocated after the first fraction of the data load has been allocated.

13. The system of claim 12, wherein the second fraction of the data load is allocated to the at least one secondary cell.

14. The system of claim 13, wherein the second fraction of the data is sent using mid-band time division duplex (TDD) frequencies.

15. The system of claim 10, wherein the radio condition metrics comprise at least one of: signal-to-interference and noise (SINK), reference signal received power (RSRP), and reference signal received quality (RSRQ).

16. The system of claim 10, wherein the congestion metrics comprise at least one of: a number of user equipments (UEs) connected to the at least one primary cell, a number of UEs connected to the at least one secondary cell, and a traffic metric.

17. The system of claim 16, wherein the traffic metric is based on a time of day.

18. The system of claim 10, wherein the first fraction allocation is transmitted by a scheduler.

19. A non-transitory computer storage media storing computer-useable instructions that, when used by one or more processors, cause the processors to:
determine radio condition metrics for a plurality of cells used for communication between the plurality of cells and a user equipment (UE);
determine a congestion metric for the plurality of cells; and
receive, from a scheduler, a first fraction of a data load allocated to a first cell of the plurality of cells, wherein the first fraction of the data load allocated to the first cell of the plurality of cells and the UE is based on the radio condition metrics and the congestion metric.

20. The non-transitory computer storage media of claim 19, wherein the radio conditions metrics are based on at least one of a signal-to-interference and noise (SINK) measurement or a reference signal received power (RSRP) measurement and the loading metric is based on a utilization rate of physical resource blocks (PRBs) and the congestion metrics are based on at least one of: a number of UEs connected to a primary cell (Pcell) and a number of UEs connected to a secondary cell (Scell), a number of UEs using an access point hosting a Pcell and a Scell, and a traffic metric based on a time of day.
